(19) United States
(12) Patent Application Publication
(10) Pub. No.: US 2005/0161914 A1
(43) Pub. Date: Jul. 28, 2005

(54) Handy collapsible shopping cart

(76) Inventor: Pui Yee Noel Lo, Yuen Long (HK)

Correspondence Address: ROSENBERG, KLEIN & LEE, 3458 ELLICOTT CENTER DRIVE-SUITE 101, ELLICOTT CITY, MD, 21043, US

(21) Appl. No.: 10/762,270

(22) Filed: Jan. 23, 2004

(51) Int. Cl. B62B 1/00

(52) U.S. Cl. 280/651

(57) ABSTRACT

A handy collapsible shopping cart includes an elongated base frame bar, two front bumper members, two wheel frame bars equipped with a respective wheel and respectively pivoted to the base frame bar at two sides, a supplementary frame bar longitudinally slidably coupled to the base frame bar, two links bilaterally coupled between the supplementary frame bar and the front bumper members, a retractable handlebar pivoted to the base frame bar and turned to move the supplementary frame bar on the base frame bar and to further move the front bumper members and the wheel frame bars between the extended operative position and the collapsed non-operative position, and a lock adapted to lock the retractable handlebar and the supplementary frame bar.

### BACKGROUND OF THE INVENTION

1. Field of the Invention

The invention relates to a light cart pushed by hand and, more particularly, to a handy collapsible shopping cart.

2. Description of the Related Art

In some countries, supermarkets and shops may provide polybags to consumers for holding purchased items. However, waste polybags may cause pollution to the environment if they are not properly disposed of. Therefore, advanced countries prohibit people from using polybags in supermarkets to hold purchased items. When going to a supermarket to purchase foods and other items, consumers may have to carry a bag or a pushcart for carrying purchased items. However, conventional pushcarts for this purpose are commonly heavy, not convenient for carrying.

### SUMMARY OF THE INVENTION

The present invention has been accomplished under the circumstances in view. It is one object of the present invention to provide a pushcart, which is folding collapsible. It is another object of the present invention to provide a handy collapsible shopping cart, which is easy to use. To achieve these and other objects of the present invention, the handy collapsible shopping cart comprises an elongated base frame bar, two front bumper members, two wheel frame bars equipped with a respective wheel and respectively pivoted to the base frame bar at two sides, the wheel frame bars each having a top sector gear, a supplementary frame bar longitudinally slidably coupled to the base frame bar, the supplementary frame bar having a bottom rack meshed with the top sector gears of the wheel frame bars and a top rack, two links bilaterally coupled between the supplementary frame bar and the front bumper members, a retractable handlebar pivoted to the base frame bar and meshed with the top rack of the supplementary frame bar, the retractable handlebar being turned to move the supplementary frame bar on the base frame bar and to further move the front bumper members and the wheel frame bars between the extended operative position and the collapsed non-operative position, and a lock adapted to lock the retractable handlebar and the supplementary frame bar.

### BRIEF DESCRIPTION OF THE DRAWINGS

FIG. 1 is an elevational view of a handy collapsible shopping cart according to the present invention.

FIG. 2 is an exploded view of the handy collapsible shopping cart according to the present invention.

FIG. 3 is a side view of the handy collapsible shopping cart according to the present invention.

FIG. 4 is an enlarged view of a part of FIG. 3, showing the lock pin of the retractable handlebar supported on the spring member and engaged into the lock hole at the base frame bar.

FIG. 5 is a sectional view of a part of the present invention, showing the coupling arrangement between the wheel frame bars and the base frame bar.

FIG. 6 is a schematic side view of the present invention showing the collapsing operation of the handy collapsible shopping cart.

FIG. 7 is a perspective view showing the handy collapsible shopping cart collapsed.

FIG. 8 is a sectional view in an enlarged scale of a part of the present invention showing the locating plates of the supplementary frame bar respectively engaged into the locating holes of the front bumper members.

FIG. 9 is a perspective view showing a bag installed in the handy collapsible shopping cart according to the present invention.

### DETAILED DESCRIPTION OF THE PREFERRED EMBODIMENT

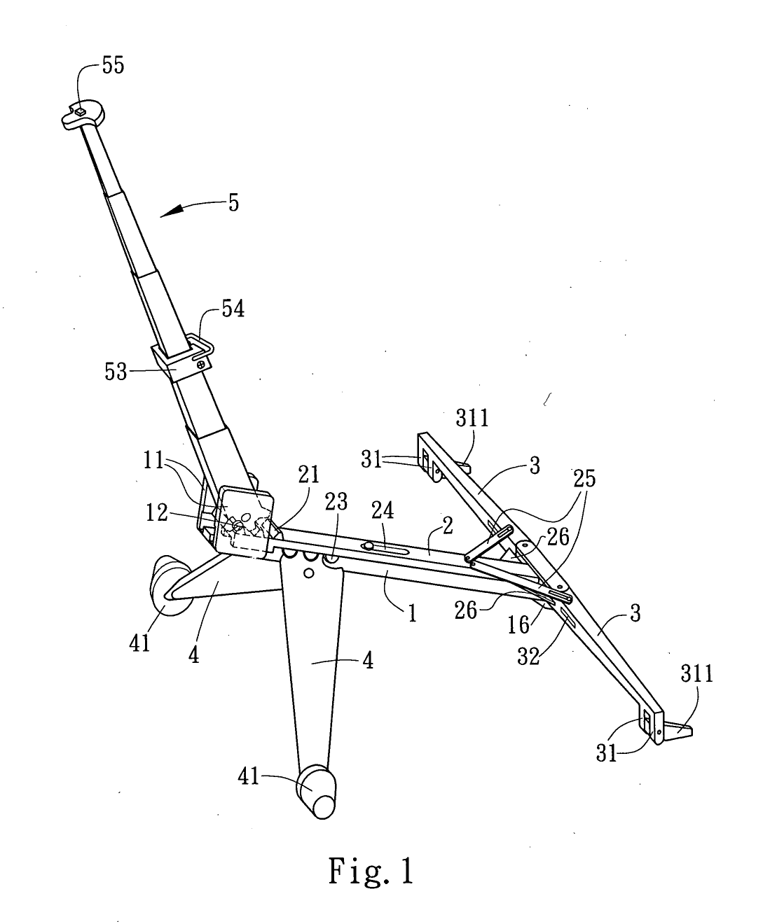

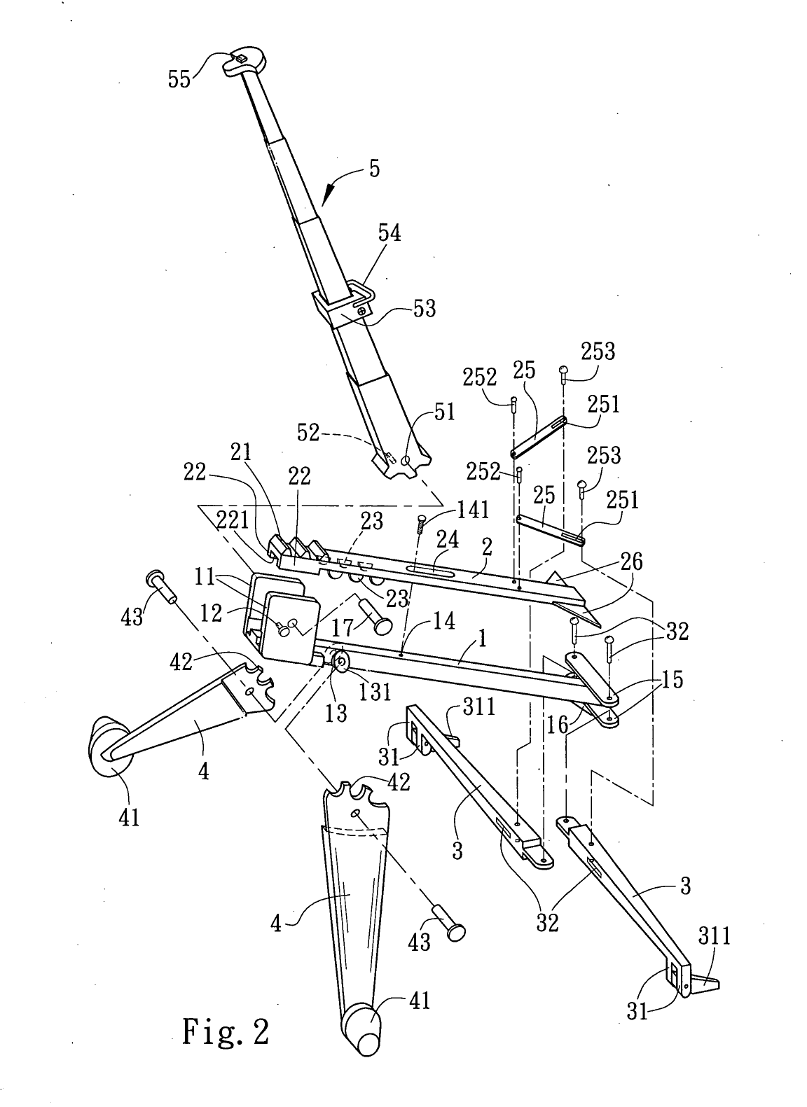

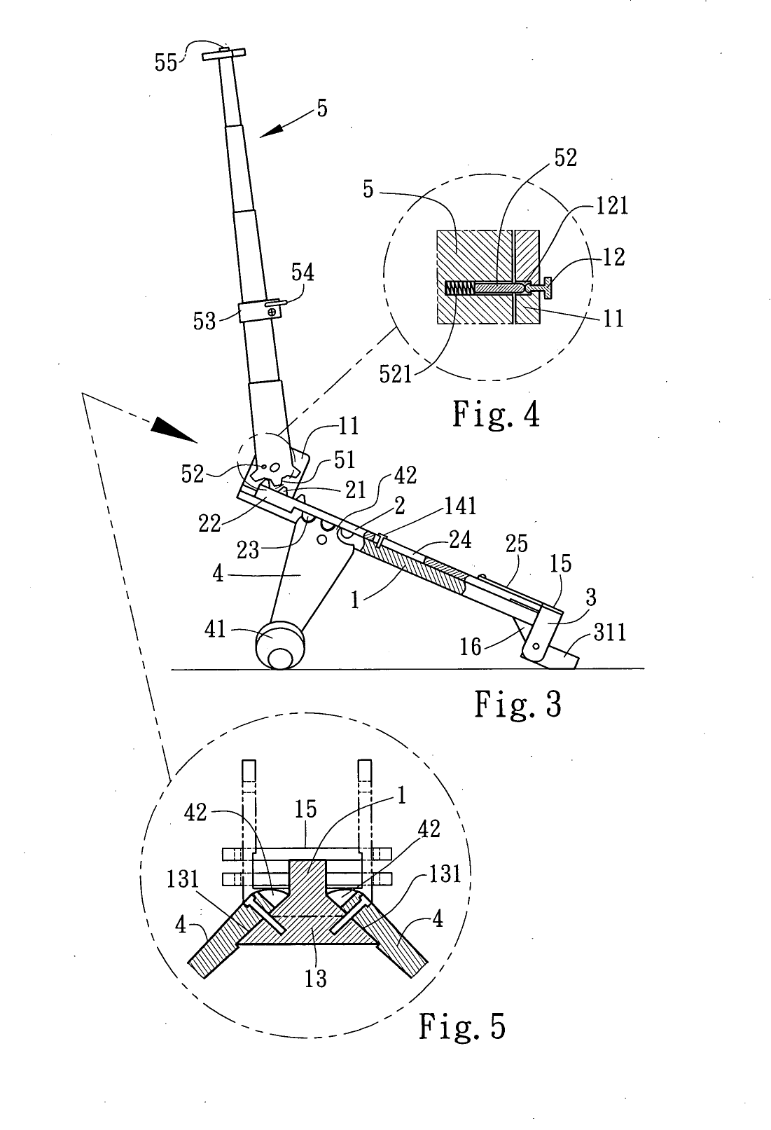

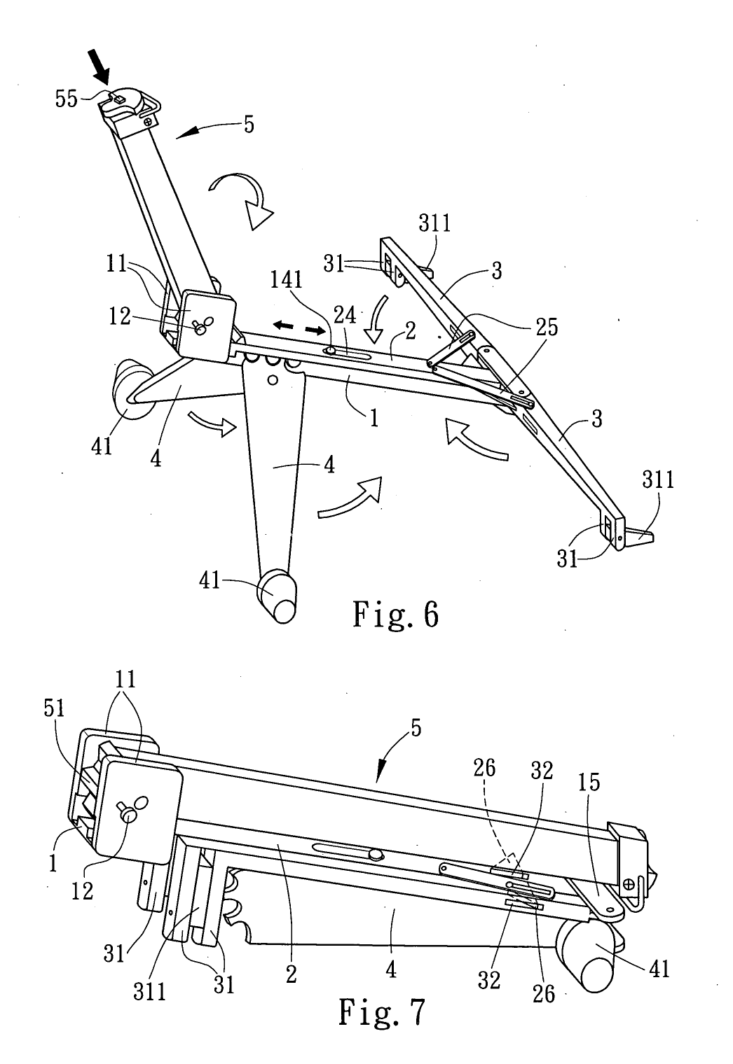

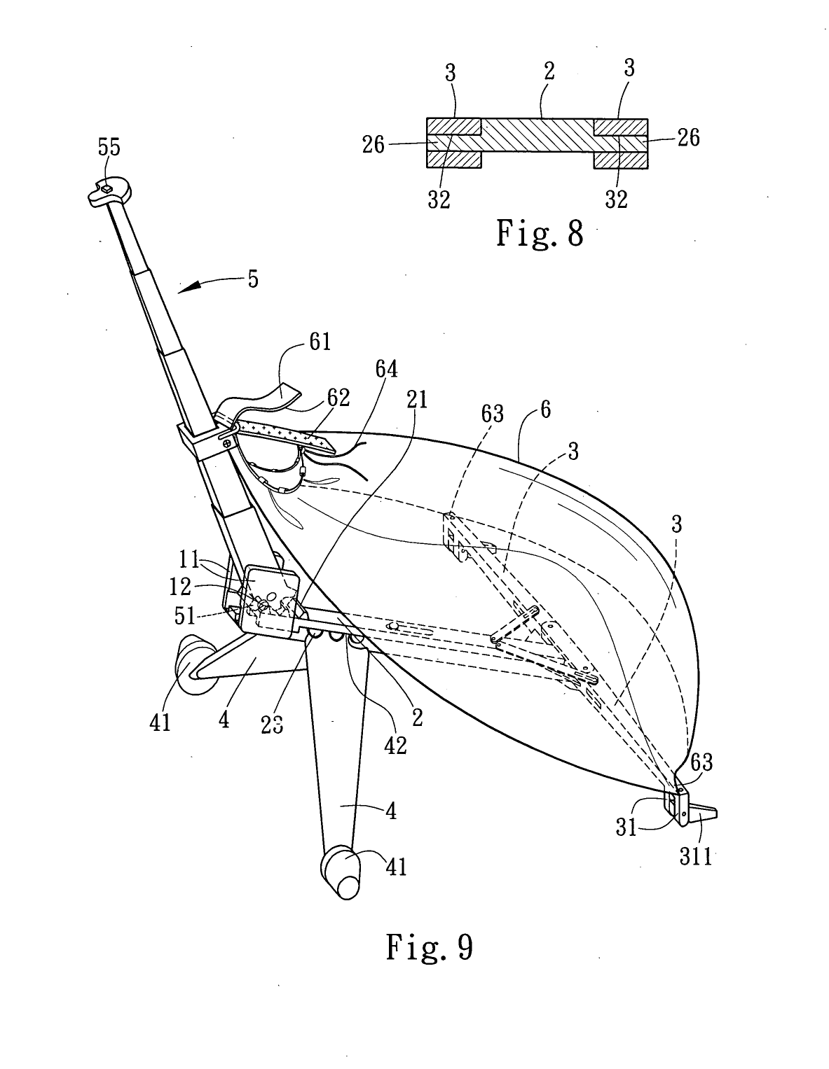

Referring to FIGS. 1, 2, 3, and 5, a handy collapsible shopping cart is shown comprising an elongated base frame bar 1, and an elongated supplementary frame bar 2 longitudinally slidably coupled to the base frame bar 1 at the top. The supplementary frame bar 2 comprises two side plates 22 longitudinally bilaterally disposed at one end and defining with the bottom wall thereof a coupling groove 221, which receives the base frame bar 1, for enabling the supplementary frame bar 2 to be moved stably along the base frame bar 1. The supplementary frame bar 2 has a sliding slot 24 longitudinally extended on the middle. A pivot pin 141 is inserted through the sliding slot 24 and fastened to a pin hole 14 on the middle of the base frame bar 1 to secure the supplementary frame bar 2 to the base frame bar 1 and to limit sliding movement of the supplementary frame bar 2 relative to the base frame bar 1 to a predetermined distance corresponding to the length of the sliding slot 24. The base frame bar 1 comprises two upright mounting plates 11 bilaterally disposed at the rear end thereof. A retractable handlebar 5 is pivotally coupled with the bottom end thereof to the base frame bar 1 between the upright mounting plates 11 by a pivot 17. The retractable handlebar 5 comprises a tooth 51 transversely disposed at the bottom end and meshed with a top rack 21 at the rear end of the supplementary frame bar 2. The base frame bar 1 comprises a mounting frame 15 transversely disposed at the front end. Two front bumper members 3 are symmetrically pivoted to the mounting frame 15 at two sides by a respective pivot 32. Two links 25 are coupled between the front bumper members 3 and the supplementary frame bar 2 at two sides. The links 25 each have one end respectively pivoted to the supplementary frame bar 2 by a respective pivot 252, and the other end provided with a longitudinal sliding slot 251 respectively pivoted to the front bumper members 3 by a respective pivot 253. Thus, the front bumper members 3 can be turned between a first position where the front bumper members 3 are longitudinally aligned in a line and extended across the base frame bar 1 (see FIGS. 1 and 6), and the second position where the front bumper members 3 are arranged in parallel and closely attached to the base frame 1 (see FIG. 7). The base frame bar 1 further comprises two coupling blocks 13 bilaterally disposed near the upright mounting plates 11. The coupling blocks 13 each have a beveled face 131. Two wheel frame bars 4 are respectively pivotally fastened to the coupling blocks 13 by a respective pivot 43, each having a bottom end provided with a wheel 41 and a top end terminating in a sector gear 42 meshed with a bottom rack 23 at the bottom side of the supplementary frame bar 2. When turning the retractable handlebar 5 forwards, the tooth 51 is forced to move the top rack 21 and the supplementary frame bar 2 backwards along the base frame bar 1. At the same time the links 25 are moved with the supplementary frame bar 2 to turn the front bumper members 3 inwards toward the base frame bar 1, and the bottom rack 23 is forced to turn the sector gears 42, causing the wheel frame bars 4 to be respectively turned forwardly upwards and closely attached to the base frame bar. Therefore, the retractable handlebar 5, the front bumper members 3 and the wheel frame bars 4 can be received and closely attached to the base frame bar 1 and the supplementary frame bar 2 (see FIGS. 6 and 7). When collapsed, the collapsed pushcart can be received in a bag or the like for carrying by hand. When in use, lift the retractable handlebar 5 from the base frame bar 1 to push the supplementary frame bar 2 forwards along the base frame bar 1, thus the front bumper members 3 and the wheel frame bars 4 are respectively turned outwards from the base frame bar 1 to the extended operative position. The retractable handlebar 5 further comprises a spring member 521 mounted in the bottom end, and a lock pin 52 transversely disposed in the bottom end and supported on the spring member 521. When extended out the handy collapsible shopping cart, the spring member 521 automatically forces the lock pin 52 into a lock hole 121 in one upright mounting plate 11 to lock the handy collapsible shopping cart in the extended position (see FIG. 4). A release button 55 is provided at the retractable handlebar 5 for pressing by the user to disengage the lock pin 52 from the lock hole 121. After disengagement of the lock pin 52 from the lock hole 121, the user can then turn the retractable handlebar 5 to collapse the handy collapsible shopping cart. Further, the front bumper members 3 each have a locating hole 32. The supplementary frame bar 2 further comprises two locating plates 26. When the collapsible pushcart collapsed, the locating plates 26 are respectively engaged into the locating holes 32 (see FIG. 8), preventing oscillation of the front bumper members 3 relative to the supplementary frame bar 2 and the base frame bar 1. Further, a bag 6 is provided at the handy collapsible shopping cart. The bag 6 has a closed bottom side 63 fastened to the front bumper members 3, and an open top side 64 hung on a hanger 53 at the retractable handlebar 5. A binding tape 61 formed of hook and loop materials 62 is inserted through a ring 54 at the retractable handlebar 5, and adapted to tie up the open top side 64 of the bag 6. In order to prevent falling of the pushcart to the ground, a fixed foot member 16 is provided at the bottom side of the front end of the base frame bar 1, and two extension blocks 311 are respectively pivoted to the free ends 31 of the front bumper members 3. When in use, the foot member 16 and the extension blocks 311 can support the pushcart stably on the floor.

A prototype of handy collapsible shopping cart has been constructed with the features of FIGS. 1˜9. The handy collapsible shopping cart functions smoothly to provide all of the features discussed earlier.

Although a particular embodiment of the invention has been described in detail for purposes of illustration, various modifications and enhancements may be made without departing from the spirit and scope of the invention. For example, the fans used can be cooling fans for use in hot weather, or fans with electric heater means for use in cold weather. Accordingly, the invention is not to be limited except as by the appended claims.

1. A handy collapsible shopping cart comprising
an elongated base frame bar, said base frame bar comprising two upright mounting plates arranged in parallel at two opposite sides of a rear end thereof, a mounting frame transversely disposed at a front end thereof, and two coupling blocks bilaterally disposed near said upright mounting plates;
an elongated supplementary frame bar coupled to said base frame bar and longitudinally movable along said base frame bar, said supplementary frame bar comprising a top rack and a bottom rack disposed at top and bottom sides of a rear end thereof;
two front bumper members respectively pivoted to the mounting frame of said base frame bar at two sides;
two links bilaterally coupled between said supplementary frame bar and said front bumper members;
two wheel frame bars respectively pivoted to the coupling blocks of said base frame bar, said wheel frame bars each having a top end, a bottom end, a sector gear fixedly provided at the top end and meshed with the bottom rack of said supplementary frame bar, and a wheel fastened pivotally with the bottom end; and
a retractable handlebar fastened pivotally with the upright mounting plates of said base frame bar by pivot means, said retractable handle bar having a tooth member fixedly provided at a bottom end thereof and meshed with the top rack of said supplementary frame bar;
wherein said retractable handlebar is turnable relative to said base frame bar to move said supplementary frame bar along said base frame bar between a first position where said retractable handlebar is closely attached to said supplementary frame bar, said wheel frame bars are turned upwardly forwards by the bottom rack of said supplementary frame bar and received to two opposite lateral sides of said base frame bar, and said links are moved with said supplementary frame bar to turn said front bumper members backwardly inwards toward said base frame bar, and a second position where said retractable handlebar, said front bumper members and said wheel frame bars are respectively extended out of said base frame bar and said supplementary frame bar.

2. The handy collapsible shopping cart as claimed in claim 1, further comprising a spring-supported lock pin provided at said retractable handlebar and engageable into a lock hole in said base frame bar and adapted to lock said retractable handlebar to said base frame bar in said second position' and a release button adapted to unlock said spring-supported lock pin from said lock hole.

3. The handy collapsible shopping cart as claimed in claim 1, wherein said supplementary frame bar comprises two side plates longitudinally disposed at two opposite lateral sides, and a longitudinal coupling groove defined between said side plates and coupled to said base frame bar.

4. The handy collapsible shopping cart as claimed in claim 1, wherein said supplementary frame bar is coupled to said base frame bar by a slip joint, said slip joint comprising a sliding slot longitudinally disposed at said supplementary frame bar on the middle, and a pivot pin inserted through said sliding slot and fixedly fastened to said base frame bar.

5. The handy collapsible shopping cart as claimed in claim 1, wherein said base frame bar comprises a foot member fixedly provided at a bottom side of the mounting frame thereof; said front bumper members each have a first end respectively pivoted to the mounting frame of said base frame bar and a second end provided with a pivoted extension block.

6. The handy collapsible shopping cart as claimed in claim 1, wherein said supplementary frame bar comprises two locating plates bilaterally disposed at a front end thereof; said front bumper members each have a locating hole, which is respectively forced into engagement with the locating plates when said retractable handlebar moved to said second position to collapse the handy collapsible shopping cart.

7. The handy collapsible shopping cart as claimed in claim 1, wherein said links each have a first end respectively pivoted to said supplementary frame bar, and a second end respectively coupled to said front bumper members by a respective slip joint.

8. The handy collapsible shopping cart as claimed in claim 1, further comprising a bag, said bag having a closed bottom side fastened to said front bumper members, and an open top side hung on a hanger at said retractable handlebar and provided with a binding tape formed of hook and loop materials.
